(19) United States
(12) Patent Application Publication
(10) Pub. No.: US 2016/0238295 A1
(43) Pub. Date: Aug. 18, 2016

(54) LOW GWP HEAT TRANSFER COMPOSITIONS

(71) Applicant: HONEYWELL INTERNATIONAL INC., Morris Plains, NJ (US)

(72) Inventors: Ankit Sethi, Buffalo, NY (US); Mark W. Spatz, East Amherst, NY (US); Samuel F. Yana Motta, East Amherst, NY (US); Elizabet del Carmen Vera Becerra, Amhersy, NY (US)

(21) Appl. No.: 15/044,244

(22) Filed: Feb. 16, 2016

Related U.S. Application Data
(60) Provisional application No. 62/117,621, filed on Feb. 18, 2015.

(51) Int. Cl. F25B 45/00; C09K 5/04

(52) U.S. Cl. CPC F25B 45/00; C09K 5/045; C09K 2205/43; C09K 2205/122; F25B 2345/002; F25B 2345/001

(57) ABSTRACT

Heat transfer compositions, methods, and systems including (a) HFC-32; (b) HFO-1234ze; and (c) either HFC-152a. In certain aspects, such compositions include (a) from about 33% to about 70% by weight of HFC-32; (b) from about 20% to about 66% by weight of HFO-1234ze; and (c) from greater than about 0% to about 30% by weight of HFC-152a. The amount of each of the components (a), (b) and (c) may be selected to ensure that the burning velocity of the composition is less than about 10, the global warming potential of the composition is less than about 500, wherein said composition exhibits a COP of within 5% of R22 in an air conditioning system operated at an ambient temperature of at least 35° C.

### CROSS REFERENCES TO RELATED APPLICATIONS

This application claims the priority benefit of U.S. Provisional Application No. 62/117,621, filed on Feb. 18, 2015, which application is a continuation-in-part of U.S. application Ser. No. 13/796,270, filed on Mar. 12, 2013, which claims priority to U.S. Provisional Application Ser. No. 61/684,883, filed Aug. 20, 2012, and is also a continuation-in-part of U.S. application Ser. No. 13/292,374, filed on Nov. 9, 2011, which claims the priority benefit of U.S. Provisional Application No. 61/413,000, filed on Nov. 12, 2010, the contents each of which are incorporated herein by reference in their entirety.

### FIELD OF THE INVENTION

This invention relates to compositions, methods and systems having utility particularly in refrigeration applications, and in particular aspects to heat transfer and refrigerant compositions useful in systems that typically utilize the refrigerant HCFC-22 for heating and/or cooling applications, particularly in high ambient temperature conditions.

### BACKGROUND

Mechanical refrigeration systems, and related heat transfer devices such as heat pumps and air conditioners, using refrigerant liquids are well known in the art for industrial, commercial and domestic uses. Chlorofluorocarbons (CFCs) were developed in the 1930s as refrigerants for such systems. However, since the 1980s the effect of CFCs on the stratospheric ozone layer has become the focus of much attention. In 1987 a number of governments signed the Montreal Protocol to protect the global environment setting forth a timetable for phasing out the CFC products. CFC's were replaced with more environmentally acceptable materials that contain hydrogen or hydrochlorofluorocarbons (HCFC's). Subsequent amendments to the Montreal protocol accelerated the phase-out of these CFCs and also scheduled the phase-out of HCFCs.

Accordingly, there has thus been an increasing need for new fluorocarbon and hydrofluorocarbon compounds and compositions that are attractive alternatives to the compositions previously used in these and other applications. For example, it has become desirable to retrofit chlorine-containing refrigeration and air conditioning systems by replacing chlorine-containing heat transfer compositions with non-chlorine-containing compounds that will not deplete the ozone layer, such as hydrofluorocarbons (HFC's). Industry in general and the heat transfer industry in particular are continually seeking new fluorocarbon based mixtures that offer alternatives to, and are considered environmentally safer substitutes for, CFCs and HCFCs. It is generally considered important, however, at least with respect to heat transfer fluids, that any potential substitute must also possess those properties present in many of the most widely used fluids, such as excellent heat transfer properties, chemical stability, low- or no-toxicity, low flammability and/or lubricant compatibility, among others. R-22 provides one example of such a refrigerant composition that is used in many refrigeration and air conditioning systems, which is being phased out for the foregoing environmental concerns.

A number of patent publications have suggested replacements for HCFC-22. That is, these patent publications have suggested refrigerant or air conditioning compositions that can be used instead of HCFC-22 in new systems to be built or installed. Among such patent publications include U.S. Pat. No. 5,185,094, U.S. Pat. No. 5,370,811, U.S. Pat. No. 5,438,849, U.S. Pat. No. 5,643,492, U.S. Pat. No. 5,709,092, U.S. Pat. No. 5,722,256, U.S. Pat. No. 6,018,952, U.S. Pat. No. 6,187,219 B1, U.S. Pat. No. 6,606,868 B1, U.S. Pat. No. 6,669,862 B1, published US application no. US 2004/00691091 A1, and published European application nos. EP 0 430169 A1, EP 0 509 673 A1 and EP 0 811 670 A1. While many of these US patents and published applications disclose ternary mixtures of difluoromethane (HFC-32), pentafluoroethane (HFC-125) and tetrafluoroethane (HFC-134a) for use in refrigeration or air conditioning systems, none of them address the ability to replace HCFC-22 to obtain a significant reduction of GWP and at the same time similar performance to R-22 without the necessity for modification of the system, especially without the necessity for replacement of the major components (e.g., compressor and expansion valve). In order to replace HCFC-22 in current HCFC-22 AC systems, for example, it is necessary that that the replacement refrigerant operating characteristics, such as evaporator superheat, cooling capacity, refrigerant mass flow rate, efficiency and pressures, are very close to that of the HCFC-22 refrigerant being replaced for the particular heat transfer and other specifications for the existing system. This match or near match in properties of the replacement refrigerant to those of HCFC-22 in the original system is essential for their use in such existing AC systems or systems designed for using HCFC-22 refrigerant, to prevent equipment replacement or modification, e.g. replacement or modification of expansion valves.

With regard to efficiency, then, it is also important to note that a loss in refrigerant thermodynamic performance or energy efficiency may have secondary environmental impacts through increased fossil fuel usage arising from an increased demand for electrical energy. Thus, it is desirable that the replacement has an equivalent or near equivalent efficiency to R-22.

Furthermore, it is generally considered desirable for CFC and/or HFC refrigerant substitutes to be effective without major engineering changes to conventional vapor compression technology currently used with CFC and/or HFC refrigerants.

Flammability is another important property for many applications. That is, it is considered either important or essential in many applications, including particularly in heat transfer applications, to use compositions which are non-flammable or have only mild flammability. Thus, it is frequently beneficial to use in such compositions compounds which are mildly flammable, or even less flammable than mildly flammable. As used herein, the term “mildly flammable” refers to compounds or compositions which are classified as being 2 L in accordance with ASHRAE standard 34 dated 2010, incorporated herein by reference. Unfortunately, many HFC's which might otherwise be desirable for used in refrigerant compositions are flammable and classified as 2 and 3 by ASHRAE. For example, the fluoroalkane difluoroethane (HFC-152a) is flammable A2 and therefore not viable for use in neat form in many applications.

Applicants have thus come to appreciate a need for compositions, and particularly heat transfer compositions that are highly advantageous in vapor compression heating and cooling systems and methods, particularly systems designed for use with R-22.

### SUMMARY

Applicants have found that the above-noted need, and other needs, can be satisfied according to one aspect of the invention by compositions, methods, uses and systems which comprise or utilize a multi-component mixture comprising, preferably consisting essentially of or consisting of: (a) HFC-32; (b) greater than 20% of HFO-1234ze, preferably transHFO-1234ze and (c) HFC-152a. In preferred, but non-limiting, aspects of the present invention, the amounts of each of the components (a), (b) and (c) are selected to ensure that the burning velocity of the composition is less than about 10, the global warming potential of the composition is less than about 500, and the capacity in AC systems, particularly systems operated within high ambient temperature conditions, is within about 10%, in further embodiments within about 5%, in further embodiments within about 2% of the capacity of R-22 in such conditions. In certain embodiments, the COP in AC systems, particularly systems operated within high ambient temperature conditions, is within about 10%, in further embodiments within about 5%, in further embodiments within about 4%, or in further embodiments within about 3% of the COP of R-22 at such conditions. In certain non-limiting embodiments, the ambient temperature is about or greater than about 35° C., about or greater than about 40° C., or about or greater than about 46° C.

In certain aspects of the foregoing or any embodiment herein, component (b) may further comprise at least one compound selected from unsaturated, —CF3 terminated propenes, unsaturated, —CF3 terminated butenes, and combinations of these, wherein the compound is a compound other than HFO-1234ze.

In certain non-limiting aspects, the present invention includes a method of replacing an existing heat transfer fluid contained in an air conditioning system used in high ambient temperature conditions comprising removing at least a portion of said existing heat transfer fluid from said system, said existing heat transfer fluid being R-22 and replacing at least a portion of said existing heat transfer fluid by introducing into said system a heat transfer composition comprising:

(a) from about 33% to about 70% by weight of HFC-32;

(b) from about 20% to about 66% by weight of HFO-1234ze, preferably of transHFO-1234ze; and

(c) from greater than about 0% to about 30% by weight of HFC-152a, provided that the amount of each of the components (a), (b) and (c) is selected to ensure that the burning velocity of the composition is less than about 10, the global warming potential of the composition is less than about 500, wherein said composition exhibits a COP of within 5% of R22 in an air conditioning system operated at an ambient temperature of at least 35° C.

In certain embodiments, component (a) is provided in an amount from about 33% to about 55% by weight. In further embodiments, component (a) is provided in an amount from about 39.5% to about 43.5% by weight, when component (c) comprises HFC-152a.

In certain embodiments, component (b) is provided in an amount from about 25% to about 60% by weight. In further embodiments, component (b) is provided in an amount from about 40% to about 60% by weight. In further embodiments, component (b) is provided in an amount from about 41.5% to about 55.5% by weight. In further embodiments, component (b) is provided in an amount from about 43.5% to about 53.5% by weight. In further embodiments, component (b) is provided in an amount from about 46.5% to about 50.5% by weight.

In certain embodiments, component (c) comprises from greater than about 0% to about 25% by weight of HFC-152a. In further embodiments, component (c) comprises from about 1% to about 22% by weight of HFC-152a. In even further embodiments, component (c) comprises from about 3% to about 22% by weight of HFC-152a. In even further embodiments, component (c) comprises from about 3% to about 17% by weight of HFC-152a. In even further embodiments, component (c) comprises from about 5% to about 15% by weight of HFC-152a. In even further embodiments, component (c) comprises from about 8% to about 12% by weight of HFC-152a.

In certain embodiments of the foregoing, the composition exhibits a COP of within 5% of R22 in an air conditioning system operated at an ambient temperature of about 40° C. In further embodiments, the composition exhibits a COP of within 4% of R22 in an air conditioning system operated at an ambient temperature of about 46° C. In even further embodiments, the composition exhibits a COP of within 3% of R22 in an air conditioning system operated at an ambient temperature of about 46° C. In even further embodiments, the composition exhibits a capacity of within 2% of R22 in an air conditioning system operated at an ambient temperature of about 46° C. In even further embodiments, the composition exhibits a COP of within 3% of R22 and a capacity of within 2% of R22 in an air conditioning system operated at an ambient temperature of about 46° C.

In certain preferred embodiments, component (b) of the present invention comprises, consists essentially of, or consists of HFO-1234ze. The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

In preferred aspects of each of the embodiments hereof, the HFO-1234ze present in the composition comprises at least about 90%, preferably at least about 95%, or preferably at least about 97%, or especially preferred at least about 99% of transHFO-1234ze.

### BRIEF DESCRIPTION OF THE FIGURES

FIG. 1 shows a schematic of the test facility used in Example 2.

### DETAILED DESCRIPTION OF PREFERRED EMBODIMENTS

R-22 is commonly used in low temperature refrigeration systems and certain air conditioning systems. It has an estimated Global Warming Potential (GWP) of 1810, which is much higher than is desired or required. Applicants have found that the compositions of the present invention satisfy in an exceptional and unexpected way the need for new compositions for such applications, particularly though not exclusively air conditioning systems, heat pump systems, and commercial refrigeration, having improved performance with respect to environmental impact while at the same time providing other important performance characteristics, such as capacity, efficiency, flammability and toxicity. In preferred embodiments the present compositions provide alternatives and/or replacements for refrigerants currently used in such applications, particularly and preferably HCFC-22, that at once have much lower GWP values and provide a refrigerant composition that has a degree of flammability that is mildly flammable or even less flammable than mildly flammable, and which have desirably low toxicity, and preferably also have a close match in cooling capacity to HCFC-22 in such systems. In certain preferred embodiments, the present compositions provide alternatives and/or replacements for refrigerants currently used in air conditioning applications, particularly in geographical areas having high ambient temperature ranges, as discussed in greater detail below.

In certain aspects of the present application, the compositions exhibit a capacity in air conditioning (AC), refrigerant, or heat pump systems within about 10%, or within about 8%, or within about 5% of the heating or cooling capacity of HCFC-22, when used under heating and cooling conditions, particularly, though not exclusively, in areas having high ambient temperatures. In preferred embodiments, the compositions exhibit a capacity in AC, refrigerant, or heat pump systems within about 2% of the heating or cooling capacity of R-22, particularly when tested under cooling conditions having an ambient temperature of about 46° C.

In certain aspects of the present application, the compositions exhibit a COP in AC, refrigerant, or heat pump systems within about 10%, or within about 8%, or within about 5% of the heating or cooling capacity of R-22, when used under heating and cooling test conditions, particularly, though not exclusively, in areas having high ambient temperatures. In certain preferred embodiments, the compositions exhibit a COP in AC, refrigerant, or heat pump systems within 5% of R22 at an ambient temperature of about 40° C.; within 4% of R22 at an ambient temperature of about 46° C.; or within 3% of R22 at an ambient temperature of about 46° C.

As used herein, the term “air conditioning system” or “AC system” refers to any system that cools or heats the air in a dwelling or other confined space located in a given ambient environment. One example of conditions that may be used to evaluate capacity in such systems is provided in the examples, below, which measure capacity of a given composition having starting air temperature, starting condenser temperature, starting evaporator temperature, and the like. One of skill in the art, however, will readily appreciate that the broad aspects of present invention are not necessarily limited to the starting conditions and parameters provided and that the test conditions may be varied in accordance with standard industry practice or otherwise as is known in the art. In preferred embodiments the ranges for condenser temperature, for example, of from about 45° C. to 70° C. for heating and cooling, and an evaporator temperature of from about 3° C. to 14° C. for a heating application and from about −20° C. to 14° C. for a cooling application. One of skill in the art would appreciate that such variation in the test procedures is intended to mimic variation of different environments and the change required of the ambient temperature in a given space.

In general, the high ambient temperature conditions in which the present systems and methods can operate with especially advantageous advantage refers to the peak temperature conditions of a given geographical area, when the ambient temperatures are seasonally at their highest (e.g. summer). Such conditions, in certain aspects, are higher than a global average (or regional average) on a given day, and in certain embodiments are significantly higher. In certain non-limiting aspects, “high ambient temperatures” include temperatures at or greater than about 35° C., at or greater than about 40° C., at or greater than about 45° C., or at or greater than about 50° C.

As mentioned above, the present invention achieves exceptional advantages in connection with air condition systems, including both stationary and mobile air conditioning systems. Preferred stationary systems are provided in the examples, below. To this end, such systems may include average ambient temperature or, preferably, high ambient temperature applications. The examples below provide typical conditions and parameters that are used for many of such applications. These conditions, while preferred in certain embodiments, are not necessarily limiting of the broad scope of the invention, as one of skill in the art will appreciate that they may be varied based on one or more of a myriad of factors, including but not limited to, ambient conditions, intended application, time of year, and the like. The compositions provided herein may be used in similar type systems or, in certain embodiments, in any alternative system where R-22 is or may be adapted for use as a refrigerant.

It is contemplated that in certain embodiments the present invention provides retrofitting methods which comprise replacing at least a substantial portion of the heat transfer fluid (including the refrigerant and optionally the lubricant) in an existing system with a composition of the present invention, particularly air conditioning systems used in high ambient temperatures, without substantial modification of the system. In certain preferred embodiments the replacement step is a drop-in replacement in the sense that no substantial redesign of the system is required and no major item of equipment needs to be replaced in order to accommodate the composition of the present invention as the heat transfer fluid.

In certain preferred embodiments, the methods comprise a drop-in replacement in which the capacity of the system is at least about 70%, preferably at least about 85%, even more preferably at least about 90%, even more preferably at least about 95%, and even more preferably at least about 98% of the system capacity prior to replacement, and preferably not greater than about 130%, even more preferably less than about 115%, even more preferably less than about 110%, and even more preferably less than about 105%. In certain embodiments, such capacity is achieved at high ambient temperature conditions.

In certain preferred embodiments, the methods comprise a drop-in replacement in which the COP of the system is at least about 70%, preferably at least about 85%, even more preferably at least about 90%, even more preferably at least about 95%, and even more preferably at least about 98% of the system capacity prior to replacement. In certain embodiments, such capacity is achieved at high ambient temperature conditions.

In certain preferred embodiments, the methods comprise a drop-in replacement in which the suction pressure and/or the discharge pressure of the system, and even more preferably both, is/are at least about 70%, more preferably at least about 90% and even more preferably at least about 95% of the suction pressure and/or the discharge pressure prior to replacement, and preferably not greater than about 130%, even more preferably less than about 115, even more preferably less than about 110%, and even more preferably less than about 105%. In certain preferred embodiments, the methods comprise a drop-in replacement in which the mass flow of the system is at least about 80%, even more preferably at least 90%, and even more preferably at least 95% of the mass flow prior to replacement, and preferably not greater than about 130%, even more preferably less than about 115, even more preferably less than about 110%, and even more preferably less than about 105%.

### Heat Transfer Compositions

The compositions of the present invention are generally adaptable for use in heat transfer applications, that is, as a heating and/or cooling medium, but are particularly well adapted for use, as mentioned above, in AC systems, or any other systems that have heretofor used R-22, particularly in high ambient conditions.

Applicants have found that use of the components of the present invention within the stated ranges is important to achieve the important but difficult to achieve combinations of properties exhibited by the present compositions, particularly in the preferred systems and methods, and that use of these same components but substantially outside of the identified ranges can have a deleterious effect on one or more of the important properties of the compositions of the invention.

In certain preferred embodiments, the HFC-32 is present in the compositions of the invention in an amount of from about 33% to about 70% by weight of the compositions. In certain preferred embodiments, the HFC-32 is present in the compositions of the invention in an amount of from about 33% to about 55% by weight of the compositions. In certain preferred embodiments, the HFC-32 is present in the compositions of the invention in an amount of from about 39.5% to about 43.5% by weight of the compositions.

In certain preferred embodiments, the second component comprises, consists essentially of, of consists of HFO-1234ze, which may be included in amount of about or greater than 20 wt. %, or from about 20% to about 66% by weight. In certain preferred embodiments, HFO-1234ze, preferably transHFO-1234ze, is included in amount of about or greater than 25 wt. %, from about 25% to about 60% by weight, from about 40 wt. % to about 60 wt. %, from about 41.5 wt. % to about 55.5 wt. %, from about 43.5 wt. % to about 53.5 wt. %, or from about 46.5 wt. % to about 50.5 wt. %.

In certain preferred aspects, HFO-1234ze comprises, consists essentially of, or consists of trans-HFO-1234ze. This second component may also include one or more additional compounds, other than HFO-1234ze, which may be selected from unsaturated —CF3 terminated propenes, unsaturated —CF3 terminated butenes, and combinations of these, but in further aspects may include one or more additional compounds other than HFO-1234ze.

As the third component, compositions of the present invention include R-152a. In certain preferred embodiments, the compositions of the present invention include HFC-152a in an amount from greater than about 0% to about 30% by weight, from greater than about 0% to about 25% by weight, or in certain embodiments from greater than about 0% to about 22% by weight. In further embodiments, HFC-152a is provided in an amount from about 1% to about 22% by weight, from about 3% to about 22% by weight, from about 3% to about 17% by weight, from about 5% to about 15% by weight, or from about 8% to about 12% by weight.

Preferred compositions include (a) from about 33% to about 55% by weight of HFC-32; (b) from about 25% to about 66% by weight of HFO-1234ze, wherein the HFO-1234ze present in the composition comprises at least about 90%, preferably at least about 95%, or preferably at least about 97%, or especially preferred at least about 99% of transHFO-1234ze; and (c) greater than about 0% to about 25% by weight of HFC-152a. In further embodiments, such compositions include (a) from about 33% to about 55% by weight of HFC-32; (b) from about 40% to about 60% by weight of HFO-1234ze wherein the HFO-1234ze present in the composition comprises at least about 90%, preferably at least about 95%, or preferably at least about 97%, or especially preferred at least about 99% of transHFO-1234ze; and (c) about 1% to about 22% by weight of HFC-152a. In even further embodiments, such compositions include (a) from about 39.5% to about 43.5% by weight of HFC-32; (b) from about 41.5% to about 55.5% by weight of HFO-1234ze wherein the HFO-1234ze present in the composition comprises at least about 90%, preferably at least about 95%, or preferably at least about 97%, or especially preferred at least about 99% of transHFO-1234ze; and (c) about 3% to about 17% by weight of HFC-152a. As with the foregoing, in certain embodiments, the (b) component in these compositions comprises, consists essentially of, or consists of HFO-1234ze.

As mentioned above, applicants have found that the compositions of the present invention are capable of achieving a difficult combination of properties, including low GWP. By way of non-limiting example, the following Table A illustrates the substantial GWP superiority of certain compositions of the present invention, which are described in parenthesis in terms of weight fraction of each component, in comparison to the GWP of HFC-22, which has a GWP of 1810.

TABLE A

| | | | | GWP |
|---|---|---|---|---|
| Group | Name | Composition | GWP | (% R22) |
| Ternary Blend | A1* | R32/1234ze(E)/ | 295 | 17% |
| R32/1234ze/R152a | | 152a(0.415/0.485/0.1) | | |

*A1 is also referred to herein as L-20 or R444B

Applicants have also surprisingly found that in each of the foregoing embodiments of the invention, particularly though not exclusively where component (b) is HFO-1234ze, preferably wherein the HFO-1234ze present in the composition comprises at least about 90%, preferably at least about 95%, or preferably at least about 97%, or especially preferred at least about 99% of transHFO-1234ze, then the burning velocity of the present compositions is substantially linearly related to the weight averaged burning velocity of the components according to the Formula I:

BVcomp=Σ(wt % i·BVi)

where BVcomp is the burning velocity of the composition, and

i is summed for each of the above listed components in the composition, and preferably the amounts of each of the above listed components are selected to ensure that BVcomp based on the finding of this unexpected formula is less than about 10, more preferably less than about 9 and even more preferably less than about 8, while at the same time the GWP of the composition is less than about 500, less than about 400, less than about 350, or less than about 300.

As also mentioned above, the compositions of the present invention exhibit a degree of hazard value of not greater than about 7. As used herein, degree of hazardousness is measured by observing the results of a cube test using the composition in question and applying a value to that test as indicated by the guidelines provided in the following table below.

HAZARD VALUE GUIDELINE TABLE

| | HAZARD |
|---|---|
| TEST RESULT | VALUE RANGE |
| No ignition). Exemplary of this hazard level | 0 |
| are the pure materials R-134a and transHFO- | |
| 1234ze. | |
| Incomplete burning process and little or no | 1-2 |
| energy imparted to indicator balls and no | |
| substantial pressure rise in the cube (all balls | |
| rise an amount that is barely observable or not | |
| all from the cube holes and essentially no | |
| movement of the cube observed). Exemplary | |
| of this hazard level is the pure material HFO- | |
| 1234yf, with a value of 2. | |
| Substantially complete burning process and | 3-5 |
| low amount of energy imparted to some of the | |
| balls and substantially no pressure rise in the | |
| the cube (some balls rise an observable small | |
| distance and return to the starting position, and | |
| essentially no movement of the cube | |
| observed). ). Exemplary of this hazard level is | |
| the pure material R-32, with a value of 4. | |
| Substantially complete burning process and | 6-7 |
| substantial amount of energy imparted to most | |
| balls and high pressure rise in the cube but | |
| little or no movement of the cube (most balls | |
| rise an observable distance and do not return to | |
| the top of the cube, but little or no movement | |
| of the cube observed). | |
| High Hazard Conditions - Rapid burning and | 8-10 |
| substantial imparted to all balls and substantial | |
| energy imparted to the cube (substantially all | |
| balls rise from the cube and do not return to the | |
| starting position, and substantial movement of | |
| the cube observed). ). Exemplary of this | |
| hazard level are the pure materials R-152a and | |
| R-600a, with values of 8 and 10 respectively. | |

The compositions of the present invention may include other components for the purpose of enhancing or providing certain functionality to the composition, or in some cases to reduce the cost of the composition. For example, refrigerant compositions according to the present invention, especially those used in vapor compression systems, include a lubricant, generally in amounts of from about 30 to about 50 percent by weight of the composition, and in some case potentially in amount greater than about 50 percent and other cases in amounts as low as about 5 percent.

Commonly used refrigeration lubricants such as Polyol Esters (POEs) and Poly Alkylene Glycols (PAGs), PAG oils, silicone oil, mineral oil, alkyl benzenes (ABs) and poly(alpha-olefin) (PAO) that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils have sufficient solubility with the refrigerant that is comprised of an iodocarbon, wherein the combination of the iodocarbon and the hydrocarbon oil are more stable than other types of lubricant. Such combinations are therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

### Heat Transfer Methods and Systems

The present methods, systems and compositions are thus adaptable for use in connection with a wide variety of heat transfer systems in general and refrigeration systems in particular, such as air-conditioning (including both stationary and mobile air conditioning systems), refrigeration (including commercial refrigeration), heat-pump systems, and the like. In certain preferred embodiments, the compositions of the present invention are used in AC systems originally designed for use with an HCFC refrigerant, such as, for example, R-22, particularly for use in high ambient temperature conditions. The preferred compositions of the present invention tend to exhibit many of the desirable characteristics of R-22 but have a GWP that is substantially lower than that of R-22 while at the same time having a capacity and/or that is substantially similar to or substantially matches, and preferably is as high as or higher than R-22. In particular, applicants have recognized that certain preferred embodiments of the present compositions tend to exhibit relatively low global warming potentials (“GWPs”), preferably less than about 1,000 and more preferably not greater than about 500.

In certain other preferred embodiments, the present compositions are used in refrigerant systems originally designed for use with R-22, particularly in high ambient temperature conditions. Preferred refrigeration compositions of the present invention may be used in refrigeration systems containing a lubricant used conventionally with R-22, such as polyolester oils, and the like, or may be used with other lubricants traditionally used with HFC refrigerants. As used herein the term “refrigeration system” refers generally to any system or apparatus, or any part or portion of such a system or apparatus, which employs a refrigerant to provide cooling. Such air refrigeration systems include, for example, air conditioners, electric refrigerators, chillers, and the like.

### EXAMPLES

The following examples are provided for the purpose of illustrating the present invention but without limiting the scope thereof.

### Example 1

### R-22 Replacements for High Ambient Condition

Below, an example air conditioning system is provided at 57° C. condensing temperature which generally corresponds to an outdoor temperature of 46° C. The degree of sub-cooling at the expansion device inlet is set to 5.55° C. The evaporating temperature is set to 8° C., which corresponds to a Indoor ambient temperature of about 27° C. The degree of superheat at evaporator outlet is set to 5.55° C. The compressor efficiency is set to 70%. The pressure drop and heat transfer in the connecting lines (suction and liquid lines) are considered negligible, and heat leakage through the compressor shell is ignored.

The following conclusions can be drawn from the table
Since R152a has higher efficiency than R1234ze, replacing R1234ze with R152a leads to increase in efficiency which is desirable for high ambient condition
Since R152a has 30% higher capacity than R1234ze, replacing R1234ze with R152a should lead to substantial increase in capacity which may lead to increase power and cause motor overload. However, it was surprisingly observed that the capacity reduced but remained within acceptable levels.
Adding R152a reduces evaporator glide which tends to improve capacity and efficiency
The discharge pressure should be preferably within 105% of R22. Additionally, the suction should not preferably be lower than 95% of R22. It can be seen from the table that R152a shows higher suction and discharge pressures than R1234ze. Hence on replacing R1234ze with R152a the suction and discharge pressures should increase. However, it was surprisingly found that on replacing R1234ze with R152a the suction and discharge pressures reduced which also leads to increase in efficiency
The composition with 10% R152a, shows closest match in capacity and efficiency with discharge and suction pressures within preferred limits.

TABLE 1
Effect of adding R152a on Performance

| | | | | | Evapo- |
|---|---|---|---|---|---|
| | | | | Dis- | rator |
| | Capac- | Effi- | Suction | charge | Glide |
| Composition | ity | ciency | Pressure | Pressure | (° C.) |
| R22 | 100% | 100% | 100% | 100% | 0 |
| R32 | 158% | 94% | 163% | 162% | 0 |
| R1234ze(E) | 48% | 100% | 45% | 52% | 0 |
| R152a | 62% | 105% | 54% | 61% | 0 |
| R32/R1234ze(E) | 100% | 97% | 99% | 107% | 7.2 |
| (41.5%/58.5%) | | | | | |
| R32/R1234ze(E)/R152a | 100% | 97% | 98% | 106% | 6.9 |
| (41.5%/53.5%/5%) | | | | | |
| R32/R1234ze(E)/R152a | 99% | 98% | 97% | 105% | 6.6 |
| (41.5%/48.5%/10%) | | | | | |
| R32/R1234ze(E)/R152a | 99% | 98% | 96% | 104% | 6.4 |
| (41.5%/43.5%/15%) | | | | | |

### Example 2

### R-22 Replacements Test in Mini-Split Air Conditioner

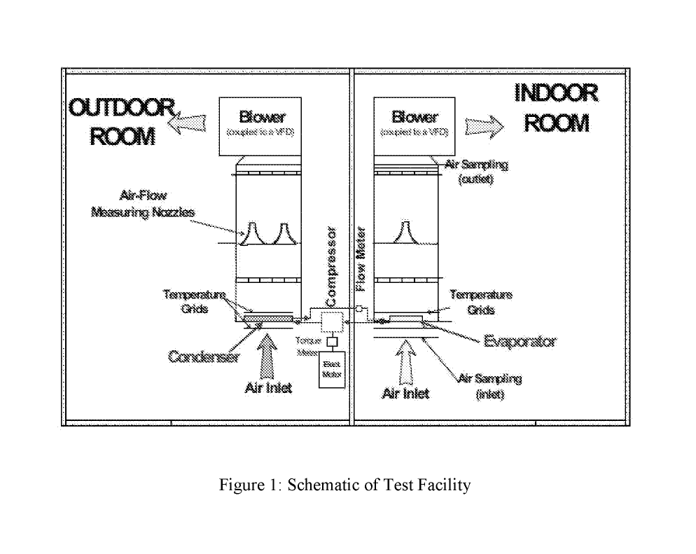

An experimental evaluation of R22, R407C (R32 23%, R125 25% and R134a 52%) and R444B (R32 41.5%, R1234ze (E) 48.5% and R152a 10%) was carried out in a mini-split air conditioner which has a capacity of 6.2 kW and EER of 9.4 at outdoor temperature of 35° C. and indoor temperature of 27° C. FIG. 1 shows a schematic of the test facility. All tests were performed inside environmental chambers equipped with instrumentation to measure both air-side and refrigerant-side parameters. Refrigerant flow was measured using a coriolis flow meter while air flow and capacity was measured using an air-enthalpy tunnel designed according to industry standards. The humidity of the air was measured using dew point meters with an accuracy of ±0.2° C. All primary measurement sensors were calibrated to ±0.15° C. for temperatures and ±0.04 kpa for pressure. The test conditions were based on ISO standard 5151 and are shown in Table 2, below.

TABLE 2
Mini-split AC Test Conditions

| Cooling Mode | |
|---|---|
| Indoor Ambient | Outdoor Ambient |

| Test | Db | WB | Db | WB |
|---|---|---|---|---|
| Condition | C | C | C | C |
| T1 | 27 | 19 | 35 | 24 |
| T3 | 29 | 19 | 46 | 24 |
| T3 max | 32 | 13 | 52 | 31 |

The performance of R444B and R407C was compared to the baseline R22 at different test conditions and is shown in Table 3. The performance of R444B is very similar to R22 for all the test conditions especially at high ambient conditions. R444B shows 4% to 7% higher efficiency than R407C which is currently used to replace R22 in air conditioning systems.

TABLE 3
Performance comparison of R-22 alternatives

| Refrigerant | Condition | Capacity % of R22 | COP % of R22 |
|---|---|---|---|
| R444B | T1 (35/27) | 99% | 98% |
| | T3 (46/29) | 100% | 100% |
| | T3(H) (52/32) | 101% | 100% |
| R407C | T1 (35/27) | 97% | 93% |
| | T3 (46/29) | 98% | 95% |
| | T3(H) (52/32) | 99% | 96% |

What is claimed is:

1. A method of replacing an existing heat transfer fluid contained in an air conditioning system used in high ambient temperature conditions comprising removing at least a portion of said existing heat transfer fluid from said system, said existing heat transfer fluid being R-22 and replacing at least a portion of said existing heat transfer fluid by introducing into said system a heat transfer composition comprising:
(a) from about 33% to about 70% by weight of HFC-32;
(b) from about 20% to about 66% by weight of HFO-1234ze, wherein the HFO-1234ze present in the composition comprises at least about 99% of transHFO-1234ze; and
(c) from greater than about 0% to about 30% by weight of HFC-152a, provided that the amount of each of the components (a), (b) and (c) is selected to ensure that the burning velocity of the composition is less than about 10, the global warming potential of the composition is less than about 500, wherein said composition exhibits a COP of within 5% of R22 in an air conditioning system operated at an ambient temperature of at least 35° C.

2. The method of claim 1, wherein component (a) is provided in an amount from about 39.5% to about 43.5% by weight.

3. The method of claim 1, wherein component (b) is provided in an amount from about 40% to about 60% by weight.

4. The method of claim 1, wherein component (b) is provided in an amount from about 46.5% to about 50.5% by weight.

5. The method of claim 1, wherein said component (b) further comprises at least one compound, other than HFO-1234ze, selected from unsaturated —CF3 terminated propenes, unsaturated —CF3 terminated butenes, and combinations of these.

6. The method of claim 1, wherein said component (c) comprises from about 3% to about 22% by weight of HFC-152a.

7. The method of claim 1, wherein said component (c) comprises from about 5% to about 15% by weight of HFC-152a.

8. The method of claim 1, wherein said composition exhibits a COP of within 3% of R22 in an air conditioning system operated at an ambient temperature of about 46° C.

9. The method of claim 1, wherein said composition exhibits a capacity of within 2% of R22 in an air conditioning system operated at an ambient temperature of about 46° C.

10. The method of claim 1, wherein said composition exhibits a COP of within 3% of R22 and a capacity of within 2% of R22 in an air conditioning system operated at an ambient temperature of about 46° C.
